(19) United States
(12) Patent Application Publication
(10) Pub. No.: US 2022/0024706 A1
(43) Pub. Date: Jan. 27, 2022

(54) HORTICULTURAL POT DISPENSING APPARATUS

(71) Applicant: Agrinomix, LLC, Oberlin, OH (US)

(72) Inventors: Robert N. Lando, Sheffield Village, OH (US); Joseph G. Smith, North Ridgeville, OH (US); Neil M. Mabrouk, Elyria, OH (US); George L. Andulics, Lorain, OH (US); Charles M. Kirschner, Strongsville, OH (US); Kane D. Hogan, Rocky River, OH (US); Damon van Zanen, Zaandijk (NL); Laurens de Boer, T Veld (NL); Robert Karl Doepper, Lakewood, OH (US)

(21) Appl. No.: 17/381,371

(22) Filed: Jul. 21, 2021

Related U.S. Application Data
(60) Provisional application No. 63/054,475, filed on Jul. 21, 2020.

(51) Int. Cl. B65G 59/10; B65G 59/08; B65G 47/91

(52) U.S. Cl. CPC B65G 59/106; B65G 2201/0235; B65G 47/912; B65G 59/08

(57) ABSTRACT

A horticultural container dispensing system has a gravity-fed pot supply source having a plurality of linearly spaced pot paths and supports a plurality of pot stacks along the pot paths in a nested configuration. A pot provisioning apparatus has retention members to selectively release an end-most one of the plurality of pots from each pot stack at a release location. A pot engagement apparatus has a plurality of pot gripper devices associated with the pot paths to selectively engage an internal surface of the end-most one of the pots in the respective pot stack at the release location. A carriage apparatus selectively translates the pot gripper devices between the release location and a dispense location. The pot gripper devices selectively disengage the internal surface of the end-most one of the pots, respectively, at the dispense location. Pot grippers and provisioning apparatuses are interchangeable to accommodate differing pot sizes and shapes.

### REFERENCE TO RELATED APPLICATIONS

This application claims the benefit of U.S. Provisional Application Ser. No. 63/054,475 filed Jul. 21, 2020, the contents of all of which are herein incorporated by reference in their entirety.

### TECHNICAL FIELD

The present disclosure relates generally to automated horticultural potting systems, and more specifically to a system, apparatus, and method for efficiently dispensing individual horticultural pots from a bulk supply, thereof.

### BACKGROUND

Horticultural containers (commonly referred to as “pots”) come in many different shapes, sizes, and can be comprised of various different materials. Commercial growers of potted flowers, trees and shrubs (commonly referred to as “plants”), for example, utilize many sizes and shapes of pots, typically comprised of plastic. In some instances, limited production runs and labor availability can drive up costs and limit production for the growers. Further, the seasonal nature of the horticulture industry can lead to extreme variability of labor requirements, based on the time of a growing cycle for a particular plant. As such, automation of planting or transplanting operations for said plants can be economically beneficial.

FIG. 1A illustrates a conventional example of a plurality of pots 10 that are typically provided in a stacked configuration 12 from the pot manufacturer in a pot stack 14. The pot stack 14 consists of a plurality of pots 10 (e.g., ten, twenty, one-hundred pots, etc.) that can be efficiently shipped from the manufacturer to the commercial grower in the stacked configuration 12. In order to prepare each of the plurality of pots 10 for soil fill and planting operations, however, each pot must be removed from the pot stack 14 such that subsequent pots can be likewise filled with soil or otherwise prepared for planting. Such a stacked configuration 12 of the plurality of pots 10 has led to the development of various machines designed to automate the operations of dispensing individual pots from the pot stack 14 for the subsequent soil filling, planting, and/or transplanting of plants thereto.

Conventional pot dispensers employ gravity to vertically drop each of the plurality of pots 10 onto a dispensing surface that is situated at a distance from a pot stack 14. Dropping the individual pots by such a distance, however, can deleteriously induce static electricity between the pots 10, whereby the static electricity can lead to failures in dispensing, such as a sticking together of multiple pots, or improper positioning of the individual pot on the dispensing surface.

Such conventional pot dispensers also typically demand a uniform shape of the pots 10 and can require a rim 16 (also called a lip) that separates the individual pots within the pot stack 14. Pots 10 with such attributes can be expensive, when even available. Conventional pot dispensers that separate pots 10 from the rims 16 or lips on the pots can also have difficulty when individual pots in the pot stack 14 are non-uniformly spaced or pressed together due to packaging or shipment. Such a lack of uniformity in spacing between pots 10 in the pot stack 14 can lead to separation issues, whereby separator blades that separate the individual pots from one another do not having enough space for the pot separation process, thus potentially causing de-stacking failures and unacceptable downtime.

Further, some conventional pot dispensers can demand thick-walled pots that are comprised of a substantially thick plastic in order to operate properly. Such thick-walled pots are often more expensive than thin-walled pots, thus increasing costs for generally no other reason than for accommodating the conventional pot dispenser.

Due to their vertical gravity-fed nature, most conventional pot dispensers typically have difficulty maintaining high dispensing speeds, and as such, may not be able to dispense pots at speeds to match downstream production rates. Conventional pot dispensers can also incur extensive setup time when changing from one size or shape of pot to another. Downtime associated with such setup time can deleteriously affect efficiency and increase costs, and may even eliminate the viability of utilizing the conventional pot dispenser for short production runs.

Some other pot dispensers are known to employ suction to remove the individual pots from the stack of pots. However, due at least in part to variabilities in pot shapes, radiuses and drainage holes in said pots, for example, such suction systems can require extensive setup, and may result in failure, thus leading to costly downtime.

### SUMMARY

The present disclosure thus provides various systems, apparatuses, and methods for dispensing individual pots from a stack of pots in a reliable and efficient manner that overcomes the deficiencies of the conventional systems heretofore known.

Accordingly, the following presents a simplified summary of the disclosure in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

In accordance with various example aspects of the disclosure, a horticultural container dispensing system is provided, wherein the system comprises a gravity-fed pot supply source having a plurality of pot paths disposed along a predetermined incline. The plurality of pot paths, for example, are linearly spaced from one another, wherein the gravity-fed pot supply source is configured to support a plurality of pot stacks along each of the plurality of pot paths. Each of the plurality of pot stacks, for example, comprises a plurality of pots in a nested configuration along the respective pot path. The gravity-feed pot supply source, for example, can comprise one or more roller conveyors disposed at the predetermined incline, wherein the predetermined incline is less than approximately 30 degrees from horizontal.

A pot provisioning apparatus, for example, has one or more retention members configured to selectively release a respective end-most one of the plurality of pots from a remainder of the plurality of pots in each of the plurality of pot stacks at a release location along the respective pot path. A pot engagement apparatus comprising a plurality of pot gripper devices respectively associated with the plurality of pot paths is further provided, wherein each of the plurality of pot gripper devices is configured to selectively engage an internal surface of the end-most one of the respective plurality of pots at the release location.

A carriage apparatus, for example, is configured to selectively translate the plurality of pot gripper devices between the release location and a dispense location. Each of the plurality of pot gripper devices, for example, is configured to selectively disengage the internal surface of the end-most one of the plurality of pots, respectively, at the dispense location.

In one example, the one or more retention members comprise a stop ledge and a stop ledge actuator, wherein the stop ledge is configured to translate between a first position and a second position via the stop ledge actuator. In the first position, for example, the stop ledge limits a translation of the respective end-most one of the plurality of pots beyond the release location along the respective plurality of pot paths. In the second position, for example, the stop ledge generally permits the translation of the respective end-most one of the plurality of pots beyond the release location along the respective plurality of pot paths.

The one or more retention members, for example, are further configured to selectively retain a position of the remainder of the plurality of pots of each of the plurality of pot stacks when the end-most one of the plurality of pots from each of the plurality of pot stacks is respectively released. For example, the one or more retention members can further comprise a pot stack backstop, a pot stack holder, and a pot stack holder actuator. The pot stack holder, for example, is configured to translate between a third position and a fourth position via the pot stack holder actuator. In the third position, for example, the pot stack holder is extended toward the pot stack backstop and limits a translation of the remainder of the plurality of pots along the respective plurality of pot paths. In the fourth position, the pot stack holder is retracted from the pot stack backstop and generally permits the translation of the plurality of pots along the respective plurality of pot paths.

In accordance with a first example embodiment, the pot provisioning apparatus comprises a pot provisioning cassette selectively operably coupled to the gravity-fed pot supply source. The pot stack holder and the pot stack holder actuator, for example, are operably coupled to the pot provisioning cassette.

One or more of the pot stack backstop and the pot stack holder actuator, for example, are selectively positioned with respect to the pot provisioning cassette based on a predetermined configuration of the plurality of pots, such as a size or a shape of the plurality of pots.

In one example, a cassette coupling apparatus associated with the pot provisioning cassette can be further provided. The cassette coupling apparatus, for example, can comprise one or more of a cassette pneumatic coupling, a cassette electrical coupling, and a cassette mechanical coupling, whereby the pot provisioning cassette can be selectively operably coupled to the gravity-fed pot supply source via the cassette coupling apparatus. For example, one or more quick-release devices can be provided to selectively secure the pot provisioning cassette to the gravity-fed pot supply source. One or more of the stop ledge actuator and pot stack holder actuator, for example, can comprise one or more of a pneumatic actuator and an electric actuator, whereby the cassette coupling apparatus further operatively couples the pot provisioning cassette to the gravity-fed pot source via the one or more quick-release devices.

The pot engagement apparatus, for example, can comprise a gripper assembly selectively operably coupled to the carriage apparatus, wherein the plurality of pot gripper devices are selectively operably coupled to the gripper assembly based on the predetermined configuration of the plurality of pots and the plurality of pot paths.

In a second example embodiment, a controller is provided and configured to control one or more of the pot provisioning apparatus, the pot engagement apparatus, and the carriage apparatus. The controller, for example, is configured to selectively control a variation in one or more of the third position and the fourth position and to control the translation of the pot stack holder between the third position and the fourth position via a control of the pot stack holder actuator. For example, the pot stack holder actuator can comprise a pot stack holder servomotor.

In another example, the controller is configured to selectively control a variation in one or more of the first position and the second position and to control the translation of the stop ledge between the first position and the second position via a control of the stop ledge actuator. The stop ledge actuator, for example, can comprise a stop ledge servomotor.

In another example, the pot provisioning apparatus further comprises a pot stack backstop actuator configured to selectively position the pot stack backstop in a fifth position and a sixth position based on the predetermined configuration of the plurality of pots. The pot stack backstop actuator, for example, can comprise a pot stack backstop servomotor, wherein the controller is further configured to control the fifth position and sixth position via a control of the pot stack backstop servomotor.

In another example, the controller is further configured to control the pot engagement apparatus and the carriage apparatus. The carriage apparatus, for example, can comprise one or more of a linear actuator and a rotary actuator, wherein the controller is further configured to translate the plurality of pot gripper devices between the release location and two or more dispense locations via a control of the one or more the linear actuator and the rotary actuator. The carriage apparatus, for example, can comprise a carriage servomotor, wherein the controller is configured to selectively translate the plurality of pot gripper devices along two or more axes between the release location and two or more dispense locations via a control of the carriage servomotor. Each the plurality of pot gripper devices, for example, can be further configured to selectively disengage the internal surface of the respective end-most one of the plurality of pots at the two or more dispense locations via a control of the plurality of pot gripper devices by the controller.

The carriage apparatus, for example, can comprise one or more of a linear actuator, a rotary actuator, and a linkage configured to translate the plurality of pot gripper devices between the release location and two or more dispense locations.

In various examples, the stop ledge and pot stack holder are configured to selectively translate in respective planes that are linearly offset from one another. The pot stack holder, for example, can comprise a friction plate having an engagement surface configured to frictionally engage an outer surface of one or more of the plurality of pots in each of the plurality of pot path. The friction plate, for example, can comprise a foam material for frictionally engaging the outer surface of the respective one or more of the plurality of pots.

In other examples, the plurality of pot gripper devices are configured to concurrently place each end-most one of the plurality of pots proximate to a dispense surface at the dispense location, wherein the dispense surface comprises one or more of a conveyor apparatus and one or more carrier trays. The one or more carrier trays, for example, can comprise two or more rows of receptacles associated with the two or more dispense locations.

In accordance with another example, the pot engagement apparatus further comprises a pneumatic release apparatus, wherein the pneumatic release apparatus comprises a pressurized gas source, a nozzle associated with each of the plurality of pot gripper devices, respectively, and a gas actuator. Each nozzle, for example, is selectively fluidly coupled to the pressurized gas source via the gas actuator. The gas actuator, for example, is configured to selectively respectively supply a burst of gas from the pressurized gas source through the nozzle toward the respective end-most one of the plurality of pots at the dispense location, thereby aiding in dispensing the end-most one of the plurality of pots at the dispense location.

In another example, each of the plurality of pot gripper devices comprises two or more gripper members operably coupled to a gripper actuator. The gripper actuator, for example, is configured to selectively translate the two or more gripper members between an engagement position and a disengagement position, wherein the two or more gripper members engage the internal surface of the respective end-most one of the plurality of pots in the engagement position, and wherein the two or more gripper members disengage the internal surface of the respective end-most one of the plurality of pots in the disengagement position.

The two or more gripper members, for example, can each comprise a respective contact surface, wherein each respective contact surface generally conforms to a contour of a respective portion of the internal surface of the plurality of pots. The gripper actuator, for example, can further comprise a pneumatic actuator configured to selectively pneumatically translate the two or more gripper members between the engagement position and the disengagement position.

To the accomplishment of the foregoing and related ends, the disclosure comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a side view of a conventional pot stack comprising a plurality of pots.

FIG. 2A is a plan view of a pot tray in accordance with various example aspects of the present disclosure.

FIG. 2B is a side view of the pot tray of FIG. 2A in accordance with various example aspects of the present disclosure.

FIG. 3 is a front perspective view of an example horticultural container dispensing system in accordance with a first embodiment including various example aspects of the present disclosure.

FIG. 4A is a top plan view of an example gravity-fed pot supply source in accordance with various example aspects of the present disclosure.

FIG. 4B is a side view of the gravity-fed pot supply source of FIG. 4A.

FIGS. 5A-5D are side views of various positions of a pot provisioning apparatus in accordance with various example aspects of the present disclosure.

FIGS. 6A-6B are side perspective views of various positions of a cassette coupling apparatus for a pot provisioning apparatus in accordance with various example aspects of the present disclosure.

FIGS. 7A-7D are side views of various positions of a pot engagement apparatus in accordance with various example aspects of the present disclosure.

FIG. 8A is a cross-sectional side view of a pot gripper device for a round pot in accordance with various example aspects of the present disclosure.

FIG. 8B is a perspective view of the pot gripper device of FIG. 8A.

FIG. 9A is a cross-sectional side view of a pot gripper device for a square pot in accordance with various example aspects of the present disclosure.

FIG. 9B is a perspective view of the pot gripper device of FIG. 9A.

FIG. 10 is a perspective view of a gripper assembly for round pots in accordance with various example aspects of the present disclosure.

FIG. 11 is a perspective view of a gripper assembly for square pots in accordance with various example aspects of the present disclosure.

FIG. 12 is a perspective view of a mounted gripper assembly for round pots in accordance with various example aspects of the present disclosure.

FIG. 13 is a front perspective view of an example horticultural container dispensing system in accordance with a second embodiment including various example aspects of the present disclosure.

FIG. 14 is a side view of a pot provisioning apparatus in accordance with various example aspects of the present disclosure.

FIG. 15 is a side view of a pot engagement apparatus at a release location in accordance with various example aspects of the present disclosure.

FIG. 16 is a side view of a pot engagement apparatus at a dispense location in accordance with various example aspects of the present disclosure.

FIG. 17 is a perspective view of a pot engagement apparatus at a dispense location in accordance with various further example aspects of the present disclosure.

FIG. 18 is a perspective view of a gravity-fed pot supply source in accordance with various example aspects of the present disclosure.

FIG. 19 is a perspective view of a gravity-fed pot supply source in accordance with various further example aspects of the present disclosure.

### DETAILED DESCRIPTION

The present disclosure is directed generally toward a system, apparatus, and method for efficiently dispensing horticultural containers from a bulk supply of said horticultural containers. Accordingly, the present disclosure will now be described with reference to the drawings, wherein like reference numerals may be used to refer to like elements throughout. It is to be understood that the description of these aspects is merely illustrative and that they should not be interpreted in a limiting sense. In the following description, for purposes of explanation, numerous specific details are set forth in order to provide a thorough understanding of the present disclosure. It will be evident to one skilled in the art, however, that the present disclosure may be practiced without these specific details. Further, the scope of the disclosure is not intended to be limited by the embodiments or examples described hereinafter with reference to the accompanying drawings, but is intended to be only limited by the appended claims and equivalents thereof.

It is also noted that the drawings are provided to give an illustration of some aspects of embodiments of the present disclosure and therefore are to be regarded as schematic only. In particular, the elements shown in the drawings are not necessarily to scale with each other, and the placement of various elements in the drawings is chosen to provide a clear understanding of the respective embodiment and is not to be construed as necessarily being a representation of the actual relative locations of the various components in implementations according to an embodiment of the disclosure. Furthermore, the features of the various embodiments and examples described herein may be combined with each other unless specifically noted otherwise.

It is also to be understood that in the following description, any direct connection or coupling between functional blocks, devices, components, circuit elements or other physical or functional units shown in the drawings or described herein could also be implemented by an indirect connection or coupling. Furthermore, it is to be appreciated that functional blocks or units shown in the drawings may be implemented as separate features or circuits in one embodiment, and may also or alternatively be fully or partially implemented in a common feature or circuit in another embodiment. For example, several functional blocks may be implemented as software running on a common processor, such as a signal processor. It is further to be understood that any connection which is described as being wire-based in the following specification may also be implemented as a wireless communication, unless noted to the contrary.

The present disclosure provides one or more systems, apparatuses, and methods for dispensing individual pots from a stack of a plurality of pots (also called a pot stack) in a reliable and efficient manner that overcomes the deficiencies of the conventional systems heretofore known. The present disclosure is particularly suited to dispensing individual pots into so-called “carrier trays” that are used by horticultural growers. For example, as illustrated in FIGS. 2A-2B, a carrier tray 100 can have one or more carrier rows 102 of pot receptacles 104 in each carrier tray, whereby each pot receptable is configured to respectively accept a pot 106 (illustrated in phantom). For example, between one and six carrier rows 102 are provided in each carrier tray 100. The carrier tray 100 can be further configured such that each carrier row 102, for example, can accommodate a plurality of pots 106, such as up to four, eight, or twelve pots. It should be noted that while the carrier tray 100 is illustrated and various examples are described herein, the present disclosure is not limited to any specific configuration of the carrier tray 100, or even the utilization of any carrier tray, in general. Accordingly, as will be appreciated in the discussion infra, the present disclosure can be implemented to dispense any number of pots 106 onto any surface and in any orientation or configuration. For example, the present disclosure can be implemented to dispense any number of rows 102 of pots 106 onto the carrier tray 100, or onto a conveyor, belt, chain, or other surface (not shown) per cycle.

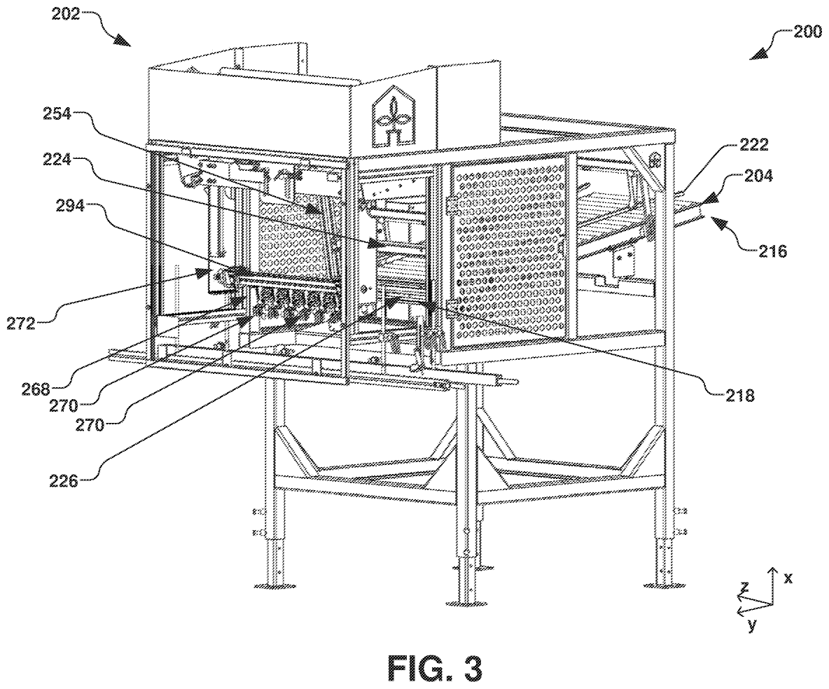

In accordance with a first embodiment of the present disclosure, one example of a horticultural container dispensing system 200 is provided in FIG. 3, whereby the horticultural container dispensing system is implemented as a base pot dispenser 202. The base pot dispenser 202 of the present example is configured to dispense a plurality of pots 106 of FIG. 2A into a single row 102 of the receptacles 104 of the carrier tray 100 per operation or cycle of the base pot dispenser. The base pot dispenser 202 of FIG. 3, for example, can be implemented as a so-called “single-tray dispenser”, whereby one carrier tray, such as the carrier tray 100 of FIG. 2A, one or more rows 102 of pot receptacles 104 can be filled with a plurality of pots 106 in one or more respective cycles of operation of the base pot dispenser. Such a base pot dispenser 202 of FIG. 3, for example, can be economical for small or limited-production operations. In one non-limiting example, the base pot dispenser 202 can be configured to cycle approximately eight-hundred times per hour. If, in such an example configuration, the plurality of pots 106 of FIG. 2A are dispensed in both of the two rows 102 of pot receptacles 104 of the example carrier tray 100, the base pot dispenser 202 of FIG. 3 could fill approximately four-hundred trays per hour with pots for subsequent soil filling, planting, or other operations downstream of the base pot dispenser.

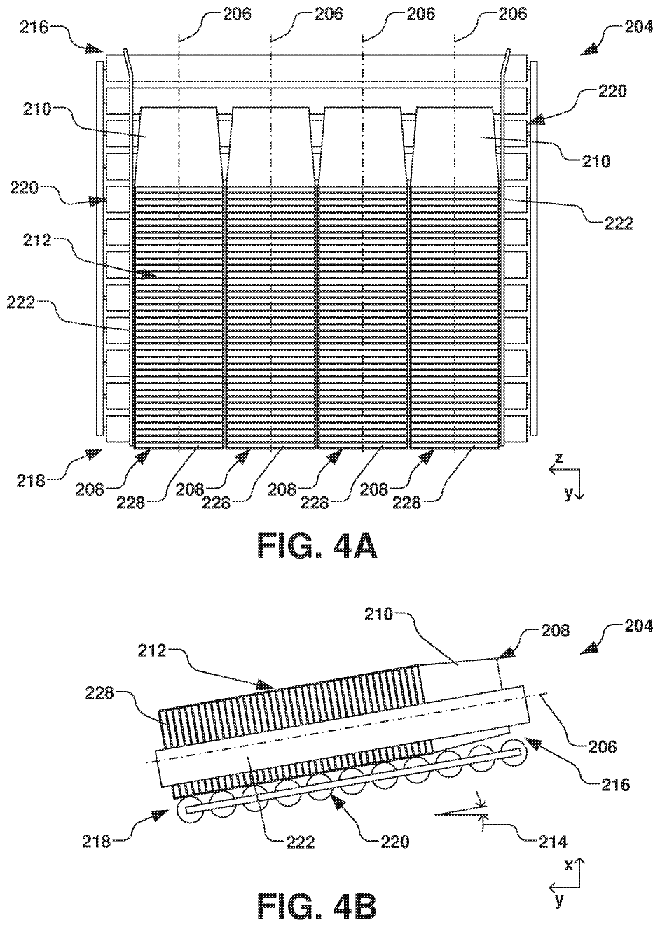

In general, as illustrated in FIG. 3, the horticultural container dispensing system 200 comprises a gravity-fed pot supply source 204 having a plurality of pot paths 206, as illustrated in further detail in FIG. 4A-4B. The plurality of pot paths 206, for example, are linearly spaced from one another, wherein the gravity-fed pot supply source 204 is configured to support a plurality of pot stacks 208 along each of the plurality of pot paths. Each of the plurality of pot stacks 208, for example, comprises a plurality of pots 210 in a nested configuration 212.

The plurality of pot paths 206, for example, are disposed along a predetermined incline 214 from horizontal, as illustrated in FIG. 4B. The predetermined incline 214, for example, generally permits gravity to force the plurality of pots 210 from a first end 216 toward a second end 218 of the gravity-fed pot supply source 204. The gravity-fed pot supply source 204, for example, comprises one or more roller conveyors 220 disposed at the predetermined incline 214, wherein the predetermined incline is less than approximately 30 degrees from horizontal. In one example, the predetermined incline 214 is approximately 20 degrees. One or more pot guides 222, for example, are further provided to guide the plurality of pots 210 along the plurality of pot paths 206. A quantity and configuration of the one or more pot guides 222, for example, is based on a configuration of the plurality of pots 210. The quantity and configuration of the one or more pot guides 222 may be further based on a desired pattern of dispensing of the plurality of pots 210, as will be discussed infra.

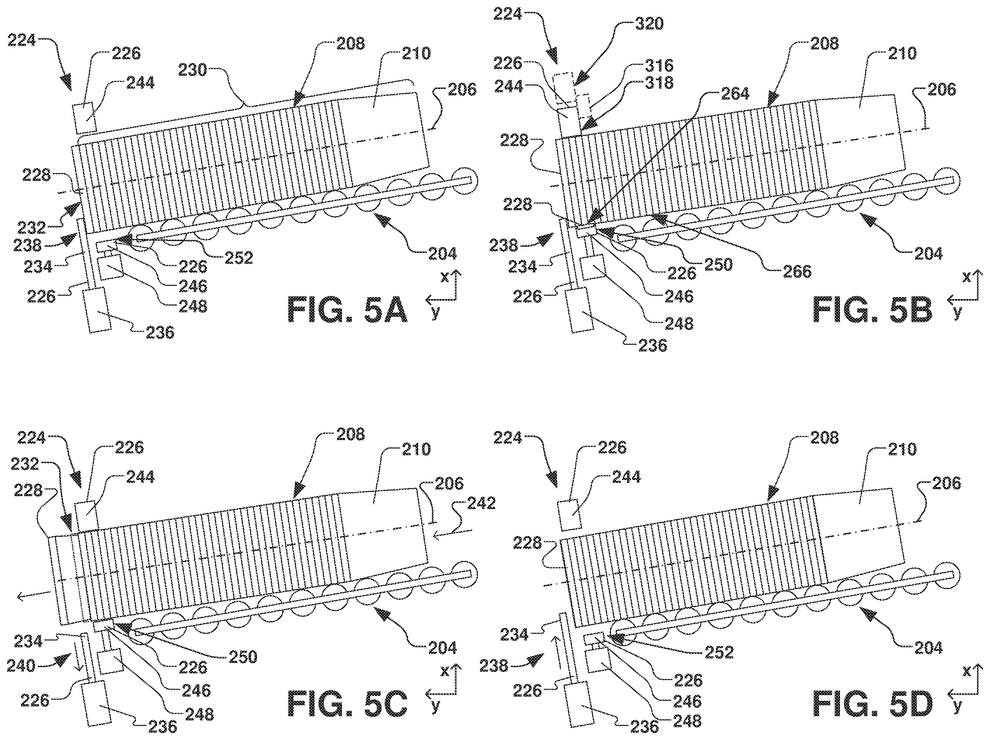

In accordance with one example, a pot provisioning apparatus 224 is illustrated in FIGS. 5A-5D. The pot provisioning apparatus 224, for example, comprises one or more retention members 226 configured to selectively release a respective end-most one 228 of the plurality of pots 210 from a remainder 230 of the plurality of pots in each of the plurality of pot stacks 208 at a release location 232. The release location 232, for example, is associated with the second end 218 of the gravity-fed pot supply source 204 shown in FIGS. 4A-4B.

In one example, the one or more retention members 226 comprise a stop ledge 234 and a stop ledge actuator 236, wherein the stop ledge is configured to translate between a first position 238 (e.g., shown in FIGS. 5A, 5B and 5D) and a second position 240 (e.g., shown in FIG. 5C) via the stop ledge actuator 236. The stop ledge actuator 236, for example, can comprise one of a pneumatic actuator, and an electric actuator, and a servomotor configured to selectively translate (e.g., linearly translate) the stop ledge 234 between the first position 238 and second position 240. In the first position 238, for example, the stop ledge 234 limits a translation of the respective end-most one 228 of the plurality of pots 210 beyond the release location 232 along the respective plurality of pot paths 206. In the second position 240, for example, the stop ledge 234 generally permits the translation (e.g., illustrated as arrow 242 in FIG. 5C) of the respective end-most one 228 of the plurality of pots 210 beyond the release location 232 along the respective plurality of pot paths 206.

The one or more retention members 226, in another example, are further configured to selectively retain the remainder 230 of the plurality of pots 210 of the plurality of pot stacks 208 along the respective plurality of pot paths 206 when the end-most one 228 of the plurality of pots from each of the plurality of pot stacks is respectively released, as discussed above. For example, the one or more retention members 226 further comprise a pot stack backstop 244, a pot stack holder 246, and a pot stack holder actuator 248. The pot stack holder 246, for example, is configured to translate between a third position 250 (e.g., illustrated in FIGS. 5B and 5C) and a fourth position 252 (e.g., illustrated in FIGS. 5A and 5D) via the pot stack holder actuator 248. The pot stack holder actuator 248, for example, can comprise one of a pneumatic actuator, and an electric actuator, and a servomotor configured to selectively translate (e.g., linearly translate) the pot stack holder 246 between the third position 250 and the fourth position 252.

In the third position 250, for example, the pot stack holder 246 is extended toward the pot stack backstop 244 and limits a translation of the remainder 230 of the plurality of pots 210 along the respective plurality of pot paths 206. In the fourth position 252, the pot stack holder 246 is retracted with respect to the pot stack backstop 244 and generally permits the translation of the plurality of pots 210 along the respective plurality of pot paths 206 with respect to the pot stack holder and pot stack backstop. In accordance with one example, the stop ledge 234 and pot stack holder 246 are configured to selectively translate in respective planes that are linearly offset from one another. In some examples, the pot stack holder 246 may be configured to lift the pot stack 208 toward the pot stack backstop 244, as illustrated in the example shown in FIGS. 5A and 5B.

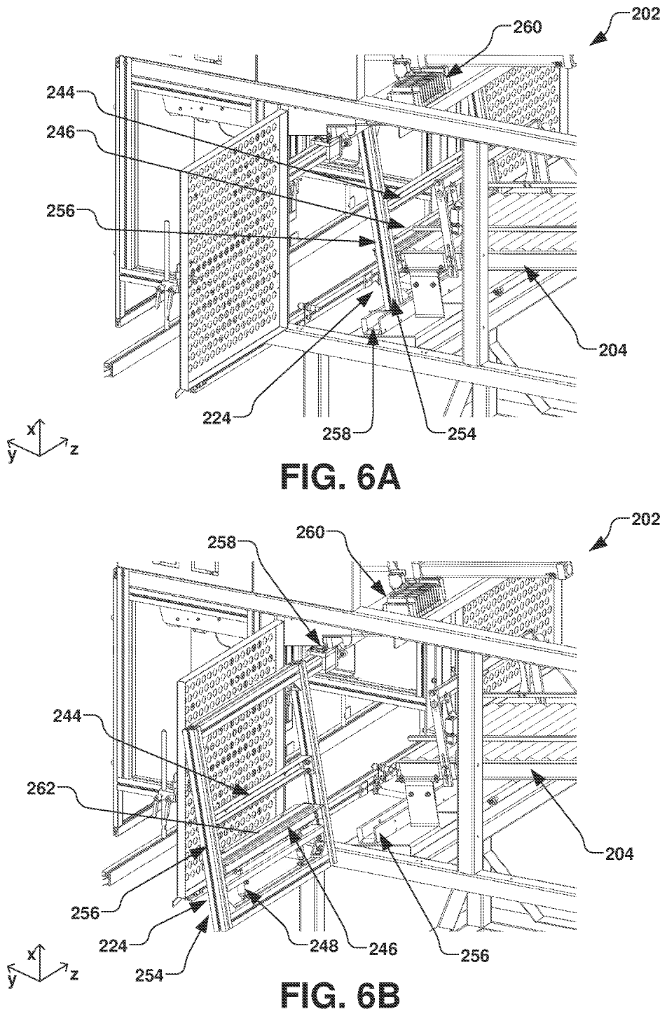

In accordance with the first embodiment, the pot provisioning apparatus 224, for example, further comprises a pot provisioning cassette 254 illustrated in FIGS. 6A-6B. The pot provisioning cassette 254, for example, selectively operably coupled to the gravity-fed pot supply source 204. One or more quick-release devices (not shown), such as a clevis pin, cam-lock, etc. can be utilized to selectively secure the pot provisioning cassette 254 to the gravity-fed pot supply source 204. The pot provisioning cassette 254, for example, is further configured to be translated and selectively removed from the base pot dispenser 202, as illustrated in FIGS. 6A-6B, as will be discussed in further detail infra. The pot stack holder 246 of FIGS. 5A-5D, for example, is operably coupled to the pot provisioning cassette 254 via at least the pot stack holder actuator 248, and the pot stack backstop 244 is further operably coupled to the pot provisioning cassette. One or more of the pot stack holder 246, pot stack holder actuator 248 and the pot stack backstop 244, for example, are selectively positioned with respect to a frame 256 of the pot provisioning cassette 254 based on a predetermined configuration of the plurality of pots, such as one or more of a predetermined size and a predetermined shape of the plurality of pots. For example, one or more of the pot stack holder actuator 248 and the pot stack backstop 244 may be moved closer to, or further away from, one another to accommodate different sizes or shapes of the pots desired to be dispensed.

For example, based on the predetermined size or shape of the plurality of pots 210, the pot stack backstop 244, for example, is selectively positionable with respect to the frame 256 in order to provide gravity-fed translation of the plurality of pots 210 between the pot stack backstop and the pot stack holder 246 when the pot stack holder is in the fourth position 252 shown in FIGS. 5A and 5D. The position of the pot stack backstop 244 along the frame can further substantially retain the plurality of pots 210 along the respective plurality of pot paths 206 when the pot stack holder 246 is in the third position 250 shown in FIGS. 5B and 5C. The pot stack backstop 244, for example, is selectively fixed in position via one or more positioning members (e.g., one or more screws, shafts, cam mechanisms, slides, rails, etc.). In an alternative example, the pot stack backstop 244 can further actively positionable with respect to the frame 256 via one or more actuators (not shown).

In one example, the pot provisioning cassette 254 is configured to be selectively removed from the base pot dispenser 202, as illustrated in FIGS. 6A-6B, whereby the frame 256 is configured to selectively engage and translate along a track 258 associated with the gravity-fed pot supply source 204. As such, the pot provisioning cassette 254, which can be pre-configured for a first size or shape of the plurality of pots can be removed entirely from the base pot dispenser 202 and replaced with a second pot provisioning cassette (not shown) that is pre-configured for a second size or shape of the plurality of pots. Accordingly, a rapid change in the configuration of the plurality of pots can be at least partially accommodated by exchanging pot provisioning cassettes 254 that have been pre-configured to particular pot styles.

According to another example, a cassette coupling apparatus 260 is further provided, wherein the cassette coupling apparatus comprises one or more of a cassette pneumatic coupling, a cassette electrical coupling, and a cassette mechanical coupling, and wherein the pot provisioning cassette 254 can be selectively operably coupled to the gravity-fed pot supply source 204 via the cassette coupling apparatus in a quick and efficient manner. For example, quick-connect couplings (not shown) may be implemented in the cassette coupling apparatus 260 for any respective pneumatic, electrical, or mechanical connections between to the selected pot provisioning cassette 254.

As illustrated in FIG. 5B, the pot stack holder 246, for example, can further comprise a friction plate 262, wherein the friction plate has an engagement surface 264 configured to frictionally engage an outer surface 266 of one or more of the plurality of pots 210 in each of the plurality of pot paths 206. The friction plate 262, for example, can comprise a foam material, rubber, or other material having sufficient friction properties to frictionally engage the outer surface 266 of the one or more of the plurality of pots 210 shown in FIG. 5B. FIG. 6B illustrates further an example of the friction plate 262 as provided in the base pot dispenser 202.

In accordance with another aspect, the horticultural container dispensing system 200, such as shown in FIG. 3, for example, further comprises a pot engagement apparatus 268 comprising a plurality of pot gripper devices 270, wherein the plurality of pot gripper devices are respectively associated with the plurality of pot paths 206 shown in FIGS. 4A-4B. Each of the plurality of pot gripper devices 270 of FIG. 3, for example, is configured to selectively engage an internal surface of the end-most one 228 of the respective plurality of pots 210 at the release location 232 shown in FIG. 5C, as will be discussed in greater detail, hereafter.

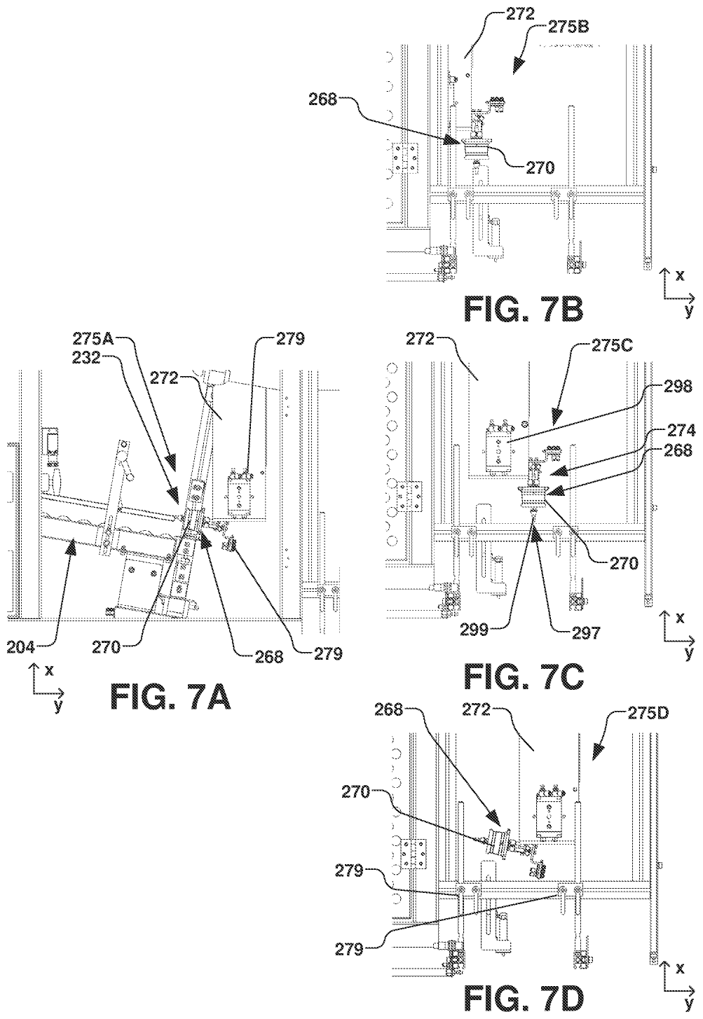

A carriage apparatus 272 is further illustrated in FIG. 3, wherein the carriage apparatus is configured to selectively translate the plurality of pot gripper devices 270 in a predetermined manner. FIGS. 7A-7D, for example illustrate several positions 275A-275D of the plurality of pot gripper devices 270, whereby the carriage apparatus 272 selectively translates the plurality of pot gripper devices the between the release location 232 shown in FIG. 5C and FIG. 7A and a dispense location 274 shown in FIG. 7C. At the dispense location 274, the plurality of pot gripper devices 270, for example, are configured to dispense each end-most one 228 of the plurality of pots 210 of FIG. 4A, for example, proximate to a dispense surface, such as one or more of a conveyor apparatus and one or more carrier trays.

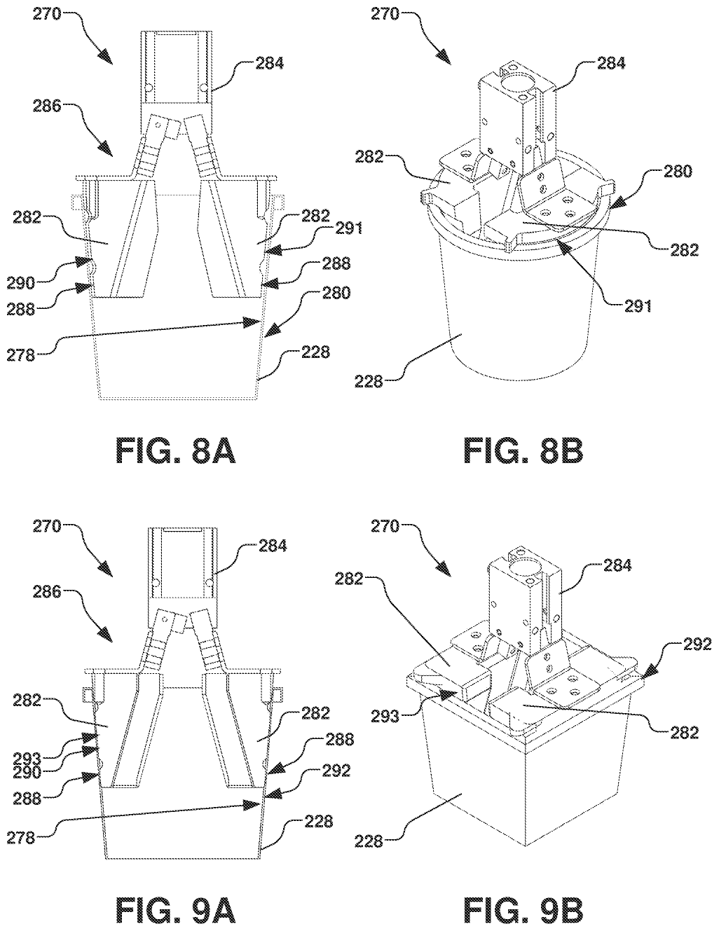

For example, the carriage apparatus 272 is configured to translate the plurality of pot gripper devices 270 through a plurality of positions 275A-275D. The carriage apparatus 272, for example, is configured to rotationally and/or linearly translate the plurality of pot gripper devices 270 along or about one or more of the x, y, and z-axis). For example, when the carriage apparatus 272 positions the plurality of pot gripper devices 270 at position 275A associated with the release location 232 of FIG. 7A, the plurality of gripper devices are configured to selectively translate into the respective end-most one 228 of the respective plurality of pots 210 shown in FIG. 4A and to selectively engage an internal surface 278, thereof, as illustrated in FIGS. 8A and 9A. In another example, the carriage apparatus 272 is configured to translate the pot engagement apparatus 268 and the plurality of pot gripper devices 270 along the y-axis (e.g., via one or more actuators, linkages, gears, etc.) in order to dispense pots into a plurality of rows of pot receptacles, such as the rows 102 of pot receptacles 104 shown in the example carrier tray 100 of FIG. 2A.

Any number of quick-connect couplings 279, for example, may be further implemented in conjunction with the carriage apparatus 272 illustrated in FIG. 7A, whereby any respective pneumatic, electrical, or mechanical connections are made to the between the plurality of pot gripper devices 270 and associated components. Such quick-connect couplings 279, for example, can allow for quick and easy tool-less changes in configurations of the plurality of pot engagement apparatus 268, as will be discussed further infra. The quick-connect couplings 279, for example, can readily provide rapid connection disconnection of air lines and/or electrical connections. In another example, the quick-connect couplings 279 can be configured to permit rapid modification of positions of various components of the carriage apparatus 272, pot gripper devices 270, etc. based on one or more conditions, such as a desired placement of the pot with respect to the carrier tray 100 of FIG. 2A.

As illustrated in FIGS. 8A-8B, for example, the end-most one 228 of the plurality of pots 210 in one of the pot stacks 208 of FIG. 4A is shown having a round configuration 280, wherein the plurality of pot gripper devices 270 comprise two or more gripper members 282 operably coupled to a gripper actuator 284 for selectively engaging and disengaging the pot. The gripper actuator 284, for example, is configured to selectively translate the two or more gripper members 282 between an engagement position 286 shown in FIG. 8A and a disengagement position (not shown). The gripper actuator 284, for example, comprises a pneumatic actuator configured to selectively pneumatically translate the two or more gripper members 282 between the engagement position 286 and the disengagement position. The gripper actuator 284, for example, may further comprise other actuator types, such as mechanical, electrical, or other actuations mechanisms having any number of gears, cams, linkages, etc.

In the engagement position 286, the two or more gripper members 282, for example, engage the internal surface 278 of the end-most one 228 of the plurality of pots in the pot stack. While not shown, in the disengagement position, the two or more gripper members 282 disengage the internal surface 278 of the end-most one 228 of the plurality of pots in the pot stack, whereby the two or more gripper members do not significantly contact the internal surface and allow the end-most one of the plurality of pots to move relative to two or more gripper members.

The two or more gripper members 282, for example, each comprise a respective contact surface 288, wherein each respective contact surface generally conforms to a contour of a respective portion 290 of the internal surface 278 of the respective plurality of pots. For example, for the round configuration 280 of the pot 210 shown in FIGS. 8A-8B, the contact surface 288 of the two or more gripper members 282 is substantially round and sized to contact the internal surface 278 of the pot, thereby defining a round gripper configuration 291.

In another example, as illustrated in FIGS. 9A-9B, an end-most one 228 of the plurality of pots 210 in one of the pot stacks 208 of FIG. 4A is shown having a square configuration 292. In a similar manner to that described above, the plurality of pot gripper devices 270 are configured to engage the internal surface 278 of the end-most one 228 of the plurality of pots in the pot stack, wherein the two or more gripper members 282, for example, each comprise a respective contact surface 288 that is either flat or angled to substantially conform to the contour of a respective portion 290 of the internal surface 278 of the pot having the square configuration 292 of the pot, thereby defining a square gripper configuration 293.

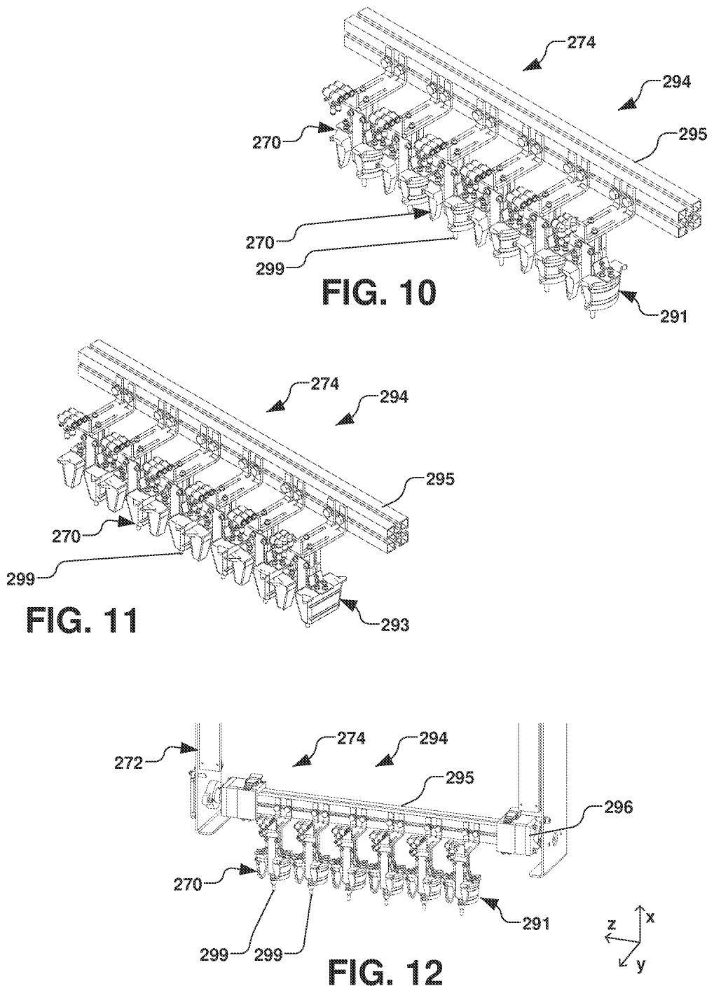

As illustrated in FIGS. 10-12, the plurality of pot gripper devices 270 of the pot engagement apparatus 268, for example, are selectively operably coupled to a gripper assembly 294 based on the predetermined configuration of the plurality of pots 210 and the plurality of pot paths 206 of FIG. 4A. The gripper assembly 294, for example, can be selectively coupled to the carriage apparatus 272 of FIG. 3, whereby a change in the predetermined configuration of the plurality of pots 210 and the plurality of pot paths 206 of FIG. 4A can be easily accommodated by a mating gripper assembly that is configured to match said configuration.

For example, as illustrated in FIG. 10, the gripper assembly 294 comprises a rail 295 onto which the plurality of pot gripper devices 270 are selectively mounted. A number of the pot gripper devices 270 shown in FIG. 10, as well as a spacing therebetween, for example, is based on the configuration of the pots 210 being dispensed. In the present example shown in FIG. 10, six pot gripper devices 270 having the round gripper configuration 291 are provided for selectively dispensing pots having the round configuration 280 shown in FIGS. 8A-8B. The spacing between the six pot gripper devices 270 of FIG. 10, for example, may be configured to match a spacing between round pot receptacles of a tray (not shown).

In the example illustrated in FIG. 11, the gripper assembly 294 the plurality of pot gripper devices 270 are selectively mounted to the rail 295 in a similar manner, whereby six pot gripper devices 270 having the square gripper configuration 293 are provided for selectively dispensing pots having the square configuration 292 shown in FIGS. 9A-9B. Again, while shown with similar spacing to that of FIG. 10, the six pot gripper devices 270, for example, may be differently spaced or configured to match a desired spacing between square pot receptacles of a tray (not shown).

FIG. 12 illustrates an example showing the rail 295 selectively mounted to the carriage apparatus 272. The carriage apparatus 272 in the present example is configured to rotate the plurality of pot gripper devices 270 about the z-axis via a rotary actuator 296, however other mechanisms for rotating the plurality of gripper devices are also contemplated, such as various gears, linkages, or other actuators.

Further, in another example, the gripper assembly 294 and the pot provisioning cassette 254 of FIG. 3, can be matched or paired to one another based on the configuration of the pots 210 being dispensed. A plurality of pairs of gripper assemblies 294 and pot provisioning cassettes 254 can be established or otherwise maintained, such that changing from one configuration of pots 210 to another can be quickly and easily accomplished by substituting a first pair of the gripper assembly 294 and the pot provisioning cassette 254 with second pair, third pair, fourth pair, etc. based on the desired configuration of pot being dispensed.

In accordance with another example, the pot engagement apparatus 268 further comprises a pneumatic release apparatus 297, as illustrated in the example shown in FIG. 7C, wherein the pneumatic release apparatus is configured to aid in a release of the pots from the plurality of pot gripper devices 270. The pneumatic release apparatus 297, for example, comprises a gas actuator 298, as well as a nozzle 299 associated with each of the plurality of pot gripper devices 270, respectively. A pressurized gas source (not shown) is selectively fluidly coupled to each nozzle via the gas actuator 298, and wherein the gas actuator is configured to selectively respectively supply a burst of gas from the pressurized gas source through the nozzle toward the respective end-most one 228 of the plurality of pots at the dispense location 274. FIGS. 10-12 further illustrate the nozzle 299 directed downward to selectively discharge the burst of gas (e.g., compressed air) to disengage the respective pots.

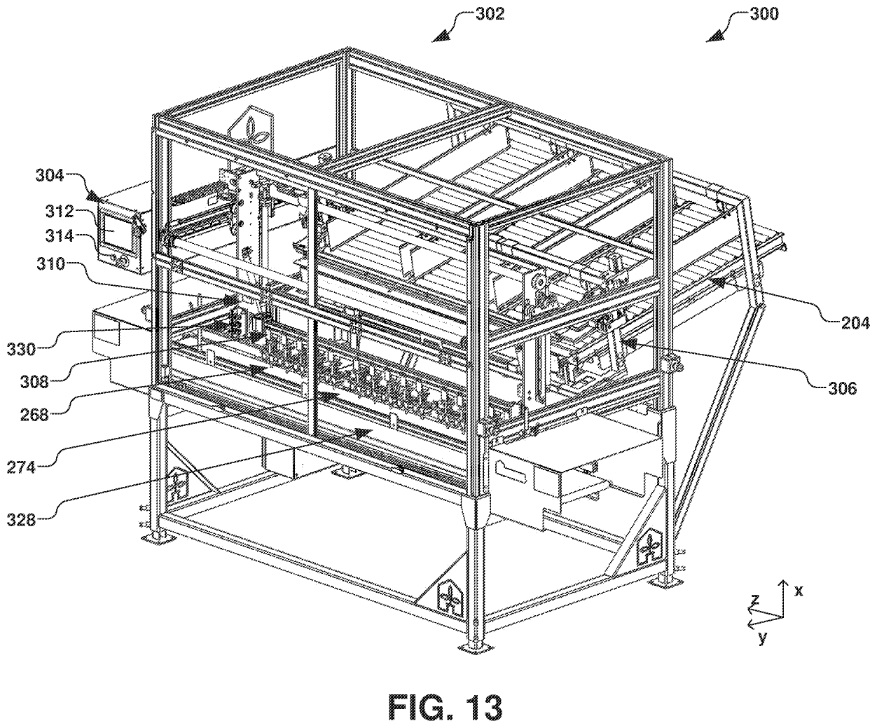

In a second example embodiment, a horticultural container dispensing system 300 is provided as an advanced pot dispenser 302, as shown in the example provided in FIG. 13. The advanced pot dispenser 302, for example, can comprise many similar components of the base pot dispenser 202 provided in FIG. 3, while providing substantial automation for various aspects, whereby the horticultural container dispensing system 300 can be implemented in larger-scale operations where substantially larger numbers of pots and/or variations in pot configurations are desired to be dispensed.

In accordance with one example, the advanced pot dispenser 302, for example, can be further configured to dispense a plurality of rows of pots into a respective plurality of tray receptacles per cycle. The plurality of rows, for example, can be co-linear or parallel, and can be associated with a plurality of pot trays, as will discussed further, infra. While a co-linear arrangement of the plurality of rows of pots can be advantageous for placement of the bulk pots along a single plane, it is understood that the present disclosure is not to be limited by such an example.

In accordance with one example aspect, the advanced pot dispenser 302 of FIG. 13 comprises a controller 304 configured to control one or more of a pot provisioning apparatus 306, a pot engagement apparatus 308, and the carriage apparatus 310 discussed above. While shown in reference to the advanced pot dispenser 302, the controller 304 may be likewise provided in conjunction with various features of the base pot dispenser 202 of FIG. 3, whereby the controller can be configured to control one or more operations of the pot provisioning apparatus 224, the pot engagement apparatus 268, and the carriage apparatus 272 discussed, heretofore.

The controller 304, for example, can comprise a touch screen 312 for user input, and/or various input controls 314, such as buttons, switches, etc., to allow for a user to control the horticultural container dispensing system 300. Accordingly, while not shown, the controller 304 can comprise various circuitry, programming, display, input devices, input power, etc. to allow for automated programming of the advanced pot dispenser in accordance with various aspects of the present disclosure.

The pot provisioning apparatus 306 of FIG. 13, for example, can comprise the one or more retention members 226 such as those discussed above, whereby the controller 304 of FIG. 13, can be configured to selectively control the one or more retention members 226. For example, the controller 304 is configured to selectively control the stop ledge actuator 236 to further control one or more of the first position 238 (e.g., shown in FIGS. 5A, 5B and 5D) and a second position 240 (e.g., shown in FIG. 5C) and translation therebetween of the stop ledge 234. For example, the stop ledge actuator 236 can comprise a servomotor configured to selectively translate (e.g., linearly translate) the stop ledge 234 between the first position 238 and second position 240, whereby the controller 304 can automatically control the first and second positions based on the predetermined configuration (e.g., size, shape, etc. input into the controller) of the pots 210 being run.

The controller 304 of FIG. 13, for example, is further configured to control the pot stack holder actuator 248 and to further control one or more of the third position 250 (e.g., illustrated in FIGS. 5B and 5C) and fourth position 252 (e.g., illustrated in FIGS. 5A and 5D) of the pot stack holder 246 via the control of the pot stack holder actuator 248. The pot stack holder actuator 248, for example, comprises a servomotor configured to selectively translate (e.g., linearly translate) the pot stack holder 246 between the third position 250 and the fourth position 252, whereby the controller 304 can automatically control the third and fourth positions based on the predetermined configuration (e.g., size, shape, etc. input into the controller) of the pots 210 being run.

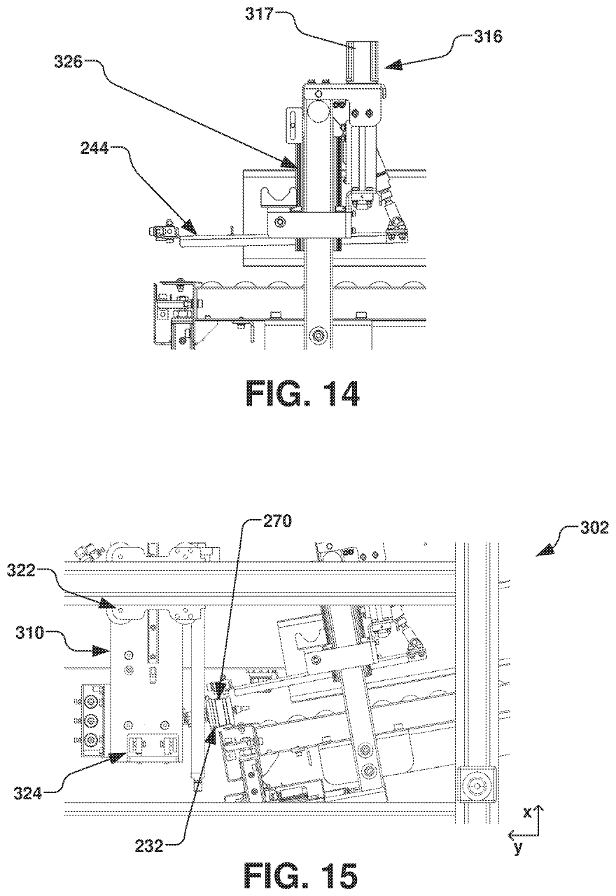

In another example, the pot provisioning apparatus 224 of FIG. 5B further comprises a pot stack backstop actuator 316 (e.g., shown in dashed lines) configured to selectively position the pot stack backstop 244 in a fifth position 318 and a sixth position 320 based on the predetermined configuration (e.g., a size, shape, etc.) of the plurality of pots 210. As illustrated in FIG. 14, the pot stack backstop actuator 316, for example, can comprise one or more respective pot stack backstop servomotors 317 configured to selectively position the pot stack backstop 244 based on input to, and control from, the controller 304.

For example, for a first configuration of pots 210 of FIG. 5B (e.g., a 4-inch diameter pot), the pot stack backstop actuator 316 can be configured to selectively position the pot stack backstop 244 in the fifth position 318, while for a second configuration of pots (e.g., a 6-inch diameter square pot), the pot stack backstop actuator can be configured to selectively position the pot stack backstop in the sixth position 320. The controller 304 of FIG. 13 can thus automatically control the fifth position 318 and sixth position 320 based on the predetermined configuration (e.g., size, shape, etc. input into the controller) of the pots 210 being run. It should be noted that the controller can allow for any number of positions of the pot stack backstop 244 based on any number of pot configurations, and the present disclosure is not limited to the examples provided above.

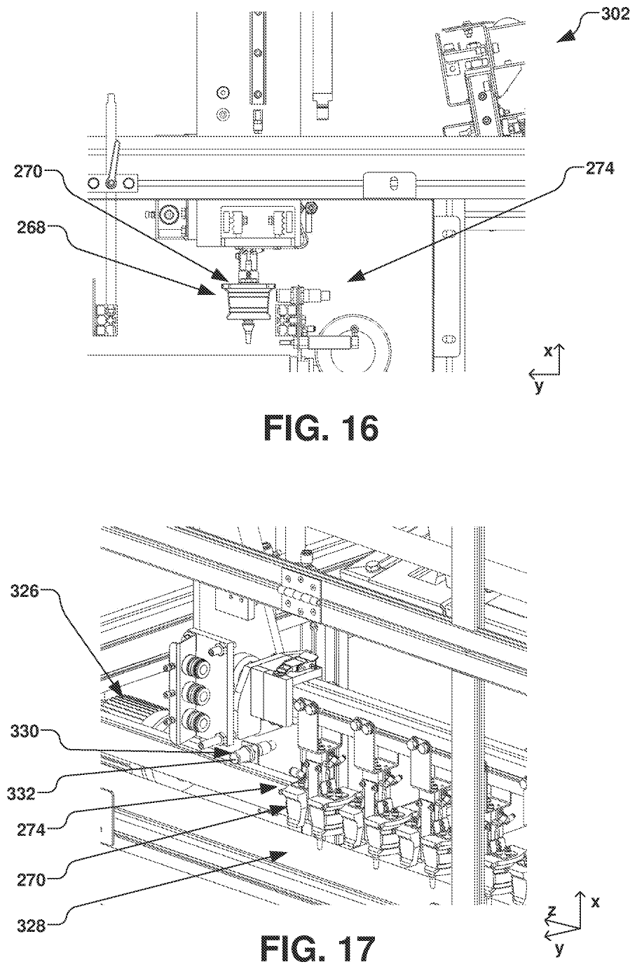

In accordance with another example, as mentioned above, the controller 304 is further configured to control the pot engagement apparatus 308 and the carriage apparatus 310. For example, the carriage apparatus 310 shown in FIG. 15 comprises one or more of a linear actuator 322 and a rotary actuator 324, wherein the controller 304 of FIG. 13 is further configured to translate the plurality of pot gripper devices 270 between the release location 232 illustrated in FIG. 15 and one or more dispense locations 274 illustrated in FIGS. 13 and 16 via a control of the one or more the linear actuator and the rotary actuator.

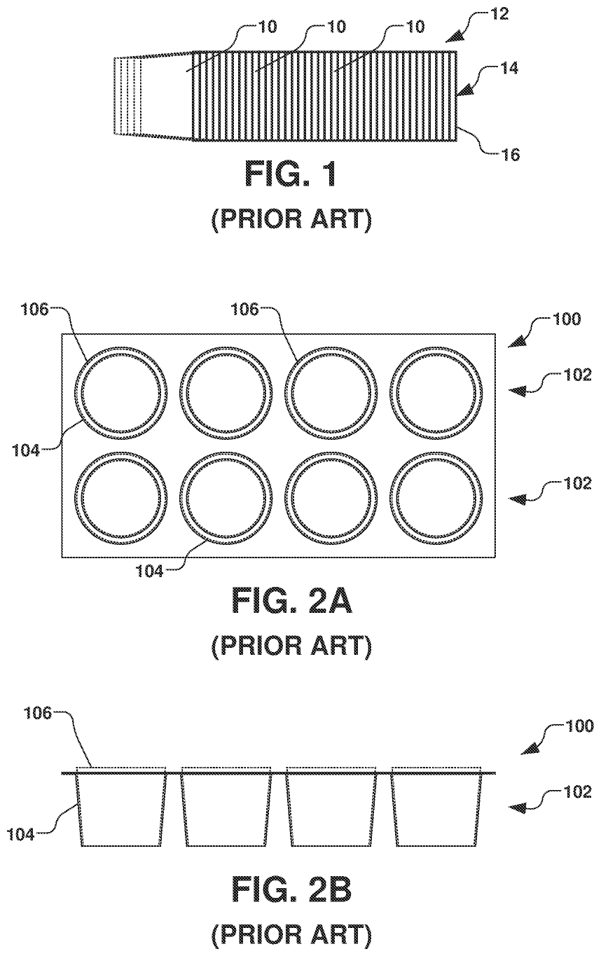

In one example, the carriage apparatus 310 illustrated in FIG. 17 comprises one or more of carriage servomotors 326 or other controllable motor. The controller 304 of FIG. 13, for example, is configured to selectively translate the plurality of pot gripper devices 270 along two or more axes (e.g., along the x-axis and y-axis and about the z-axis) via a control of the one or more carriage servomotors. The controller 304 is further configured such that each the plurality of pot gripper devices 270, for example, selectively disengages the internal surface of the respective end-most one 228 of the plurality of pots 210 of FIGS. 8A, 9A at the two or more dispense locations 274, such as illustrated in FIGS. 13 and 17. The two or more dispense locations 274, for example, can be offset in the y-direction to accommodate multiple rows 102 of a single tray 100 of FIG. 1 and/or a plurality of trays disposed along the z-axis, such as can be provided on a conveyor 328 (e.g., a conveyor belt, conveyor chain, etc.) shown in FIG. 17.

The present disclosure further provides, in another example, one or more feedback devices 330 (e.g., limit switches, proximity sensors, etc.), whereby the one or more feedback devices provide positional information associated with one or more of the pot provisioning apparatus 306, pot engagement apparatus 308, and the carriage apparatus 310 of FIG. 13 to the controller 304 for accurate control, thereof. For example, the one or more feedback devices 330 of FIG. 17 can comprise a proximity sensor 332 configured to detect a presence of one or more trays (not shown) on the conveyor 328, whereby the conveyor belt is selectively stopped when the one or more trays are properly positioned at the one or more dispense locations 274. Accordingly, dispensing of the end-most ones 228 of the plurality of pots 210 in each pot stack 208 of FIGS. 4A-4B can be selectively begun upon properly sensing the position of the one or more trays.

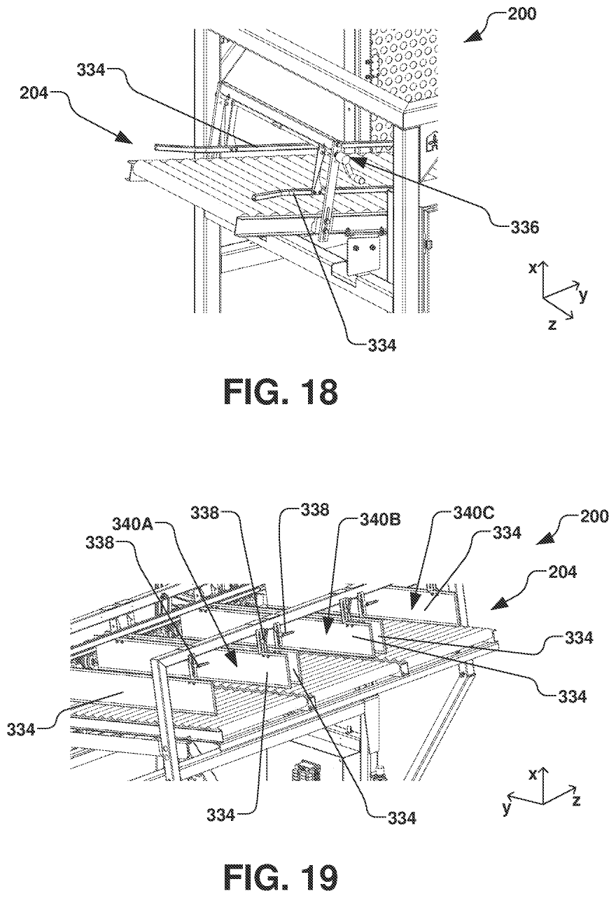

FIGS. 18-19 illustrate another example in accordance with the present disclosure, whereby one or more nested pot guides 334 are provided in association with the gravity-fed pot supply source 204. The one or more nested pot guides 334, for example, are selectively positioned with respect to the gravity-fed pot supply source 204 such that the plurality of pot paths 206 of the plurality of pot stacks 208 of FIG. 4A, for example, align the respective plurality of pots 210 at the release location 232 of FIG. 5C associated with each of the plurality of pot gripper devices 270 of FIGS. 3 and 13 for the respective horticultural container dispensing system 200, 300. The one or more nested pot guides 334 of FIGS. 18-19, for example, are selectively translatable along the z-axis, such as via one or more of screw-drive apparatus 336 shown in FIG. 18 and one or more quick-lock slide apparatuses 338 shown in FIG. 19. The one or more nested pot guides 334 shown in FIG. 19, for example, can be configured to in a plurality of groupings 340A, 340B, 340C associated with a respective plurality of trays 100 of FIG. 1 that are linearly spaced on the conveyor 328 along the z-axis of FIG. 17, whereby the respective rows 102 of the plurality of trays are co-linear.

The present disclosure thus advantageously permits a modification of pot sizes in a quick and easy manner. Exchanging components of the horticultural container dispensing systems 200, 300, for example, can be provided within a safety cage that can be further interlocked for operational safety. An operator, for example, can open the safety cage and remove a limited number of connectors between the pot handling manifold and respective single-tray dispenser or multiple-tray dispenser (e.g., one or more of compressed air fittings, electrical connections, mechanical connections, etc.) to reconfigure the respective system via a selective coupling and decoupling of various components discussed above.

The present disclosure is not to be limited by the number, orientation, or configuration of the pots, carrier trays, manifolds, or configurations of the example apparatus, and a multitude of other variations are considered to fall within the scope of the present disclosure, as would be appreciated by one of ordinary skill upon viewing the present disclosure.

Although the disclosure has been shown and described with respect to a certain embodiment or embodiments, it should be noted that the above-described embodiments serve only as examples for implementations of some embodiments of the present disclosure, and the application of the present disclosure is not restricted to these embodiments. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the disclosure. In addition, while a particular feature of the disclosure may have been disclosed with respect to only one of several embodiments, such feature may be combined with one or more other features of the other embodiments as may be desired and advantageous for any given or particular application. Accordingly, the present disclosure is not to be limited to the above-described embodiments, but is intended to be limited only by the appended claims and equivalents thereof.

1. A horticultural container dispensing system, comprising:
a gravity-fed pot supply source having a plurality of pot paths disposed along a predetermined incline, wherein the plurality of pot paths are linearly spaced from one another, wherein the gravity-fed pot supply source is configured to support a plurality of pot stacks along each of the plurality of pot paths, and wherein each of the plurality of pot stacks comprises a plurality of pots in a nested configuration;
a pot provisioning apparatus comprising one or more retention members configured to selectively release a respective end-most one of the plurality of pots from a remainder of the plurality of pots in each of the plurality of pot stacks at a release location;
a pot engagement apparatus comprising a plurality of pot gripper devices respectively associated with the plurality of pot paths, wherein each of the plurality of pot gripper devices is configured to selectively engage an internal surface of the end-most one of the respective plurality of pots at the release location; and
a carriage apparatus configured to selectively translate the plurality of pot gripper devices between the release location and a dispense location, wherein each of the plurality of pot gripper devices is configured to selectively disengage the internal surface of the end-most one of the plurality of pots, respectively, at the dispense location.

2. The horticultural container dispensing system of claim 1, wherein the one or more retention members comprise a stop ledge and a stop ledge actuator, wherein the stop ledge is configured to translate between a first position and a second position via the stop ledge actuator, wherein in the first position, the stop ledge limits a translation of the respective end-most one of the plurality of pots beyond the release location along the respective plurality of pot paths, and wherein in the second position, the stop ledge generally permits the translation of the respective end-most one of the plurality of pots beyond the release location along the respective plurality of pot paths.

3. The horticultural container dispensing system of claim 2, wherein the one or more retention members are further configured to selectively retain the remainder of the plurality of pots of the plurality of pot stacks along the respective plurality of pot paths when the end-most one of the plurality of pots from each of the plurality of pot stacks is respectively released.

4. The horticultural container dispensing system of claim 3, wherein the one or more retention members further comprise a pot stack backstop, a pot stack holder, and a pot stack holder actuator, wherein the pot stack holder is configured to translate between a third position and a fourth position via the pot stack holder actuator, wherein in the third position, the pot stack holder is extended toward the pot stack backstop and limits a translation of the remainder of the plurality of pots along the respective plurality of pot paths, and wherein in the fourth position, the pot stack holder is retracted from the pot stack backstop and generally permits the translation of the plurality of pots along the respective plurality of pot paths.

5. The horticultural container dispensing system of claim 4, wherein the pot provisioning apparatus further comprises a pot provisioning cassette selectively operably coupled to the gravity-fed pot supply source, wherein the pot stack holder is operably coupled to the pot provisioning cassette via the pot stack actuator, and wherein the pot stack backstop operably coupled to the pot provisioning cassette and is selectively positioned with respect to the pot provisioning cassette based on a predetermined configuration of the plurality of pots.

6. The horticultural container dispensing system of claim 5, wherein the predetermined configuration of the plurality of pots comprises one or more of a predetermined size of the plurality of pots and a predetermined shape of the plurality of pots.

7. The horticultural container dispensing system of claim 5, further comprising a cassette coupling apparatus, wherein the cassette coupling apparatus comprises one or more of a cassette pneumatic coupling, a cassette electrical coupling, and a cassette mechanical coupling, and wherein the pot provisioning cassette is selectively operably coupled to the gravity-fed pot supply source via the cassette coupling apparatus.

8. The horticultural container dispensing system of claim 5, wherein the stop ledge actuator and pot stack holder actuator comprise one or more of a pneumatic actuator and an electric actuator.

9. The horticultural container dispensing system of claim 5, wherein the pot engagement apparatus comprises a gripper assembly selectively operably coupled to the carriage apparatus, wherein the plurality of pot gripper devices are selectively operably coupled to the gripper assembly based on the predetermined configuration of the plurality of pots and the plurality of pot paths.

10. The horticultural container dispensing system of claim 4, further comprising a controller configured to control one or more of the pot provisioning apparatus, the pot engagement apparatus, and the carriage apparatus.

11. The horticultural container dispensing system of claim 10, wherein the controller is further configured to selectively control the third position and the fourth position via the pot stack holder actuator based on a predetermined configuration of the plurality of pots.

12. The horticultural container dispensing system of claim 11, wherein the pot provisioning apparatus further comprises a pot stack backstop actuator configured to selectively position the pot stack backstop in a fifth position and a sixth position based on the predetermined configuration of the plurality of pots.

13. The horticultural container dispensing system of claim 12, wherein the controller is further configured to selectively control the fifth position and the sixth position via the pot stack backstop actuator based on the predetermined configuration of the plurality of pots.

14. The horticultural container dispensing system of claim 12, wherein one or more of the pot stack holder actuator and pot stack backstop actuator comprise one or more respective servomotors.

15. The horticultural container dispensing system of claim 11, wherein the controller is further configured to control the pot engagement apparatus and the carriage apparatus.

16. The horticultural container dispensing system of claim 15, wherein the carriage apparatus comprises one or more of a linear actuator and a rotary actuator, wherein the controller is further configured to translate the plurality of pot gripper devices between the release location and two or more dispense locations via a control of the one or more the linear actuator and the rotary actuator.

17. The horticultural container dispensing system of claim 15, wherein the carriage apparatus comprises a carriage servomotor, wherein the controller is configured to selectively translate the plurality of pot gripper devices along two or more axes between the release location and two or more dispense locations via a control of the carriage servomotor, wherein each the plurality of pot gripper devices is configured to selectively disengage the internal surface of the respective end-most one of the plurality of pots at the two or more dispense locations.

18. The horticultural container dispensing system of claim 4, wherein the carriage apparatus comprises one or more of a linear actuator, a rotary actuator, and a linkage configured to translate the plurality of pot gripper devices between the release location and two or more dispense locations.

19. The horticultural container dispensing system of claim 4, wherein the stop ledge and pot stack holder and are configured to selectively translate in respective planes that are linearly offset from one another.

20. The horticultural container dispensing system of claim 4, wherein the pot stack holder comprises a friction plate having an engagement surface configured to frictionally engage an outer surface of one or more of the plurality of pots in each of the plurality of pot path.

21. The horticultural container dispensing system of claim 20, wherein the friction plate comprises a foam material.

22. The horticultural container dispensing system of claim 1, wherein the pot engagement apparatus is configured to concurrently place each end-most one of the plurality of pots proximate to a dispense surface at the dispense location, wherein the dispense surface comprises one or more of a conveyor apparatus and one or more carrier trays.

23. The horticultural container dispensing system of claim 1, wherein the pot engagement apparatus further comprises a pneumatic release apparatus, wherein the pneumatic release apparatus comprises:
a pressurized gas source;
a nozzle associated with each of the plurality of pot gripper devices, respectively; and
a gas actuator, wherein each nozzle is selectively fluidly coupled to the pressurized gas source via the gas actuator, and wherein the gas actuator is configured to selectively respectively supply a burst of gas from the pressurized gas source through the nozzle toward the respective end-most one of the plurality of pots at the dispense location.

24. The horticultural container dispensing system of claim 1, wherein each of the plurality of pot gripper devices comprises two or more gripper members operably coupled to a gripper actuator, wherein the gripper actuator is configured to selectively translate the two or more gripper members between an engagement position and a disengagement position, wherein the two or more gripper members engage the internal surface of the respective end-most one of the plurality of pots in the engagement position, and wherein the two or more gripper members disengage the internal surface of the respective end-most one of the plurality of pots in the disengagement position.

25. The horticultural container dispensing system of claim 24, wherein the two or more gripper members each comprise a respective contact surface, wherein each respective contact surface generally conforms to a contour of a respective portion of the internal surface of the plurality of pots.

26. The horticultural container dispensing system of claim 24, wherein the gripper actuator comprises a pneumatic actuator configured to selectively pneumatically translate the two or more gripper members between the engagement position and the disengagement position.

27. The horticultural container dispensing system of claim 1, wherein the gravity-feed pot supply source comprises one or more roller conveyors disposed at the predetermined incline, wherein the predetermined incline is less than approximately 30 degrees from horizontal.
